(19) United States
(12) Patent Application Publication
(10) Pub. No.: US 2016/0071160 A1
(43) Pub. Date: Mar. 10, 2016

(54) MAXIMUM PROFIT GOAL SOFTWARE SYSTEM

(71) Applicant: Nawar Abdullah Ahmed, Allen Park, MI (US)

(72) Inventor: Nawar Abdullah Ahmed, Allen Park, MI (US)

(73) Assignee: Nawar Abdullah Ahmed, Allen Paark, MI (US)

(21) Appl. No.: 14/696,905

(22) Filed: Apr. 27, 2015

Related U.S. Application Data
(63) Continuation of application No. 61/985,475, filed on Apr. 29, 2014.

(51) Int. Cl. G06Q 30/02

(52) U.S. Cl. CPC G06Q 30/0269; G06Q 50/188

(57) ABSTRACT

This invention relates to a system and method to enable a business to meet its business goals. Disclosed are certain non-limiting exemplary embodiments which teach a method for reducing the risk a business takes when doing business with customers in an environment where equal pricing is not the best strategy. Based on the business goal information entered into the system, the rating of the user, and other factors determined by the business, it will automatically calculate and make offers to interested users. This invention is particularly suited for the service industry. In one embodiment, a user can request and make payment for travel services.

### BACKGROUND

This invention relates to a method and system for helping a business achieve their profit goals. Sometimes having equal pricing for a product or service isn't the best pricing strategy for the business or the consumer. Equal pricing can result in the failure of a business to meet its goals for the month.

Some customers are more demanding, requiring more time than expected, thus reducing the profit. Some customers ask for extras, like extra towels or a beard trim with your haircut, without wanting to pay for them. A customer may simply ask lots of questions or want to stand around talking, while the time clock is running. Sometimes a customer will get many quotes, but not engage in a business transaction.

Sometimes a customer destroys property, thus reducing the profit. Some customers may leave a mess in the bathroom, let kids drop food or drink and not clean up, leave trash on your property or put a hole in the wall. It isn't always possible to know who the customers are ahead of time. All of this costs in time and materials, thus reducing profit for a business.

Further, businesses don't always know how to maximize their profits. They don't know what they need on a daily basis to break-even. It is even more difficult to figure out how much an individual job or customer will cost a business. Some businesses are referred to as a business of pennies. If a business makes a few dollars on each customer during a day, but one customer ends up costing business money, the business can have a net loss that day. For example, one required carpet cleaning could result in a net loss over several days that could have otherwise been profitable days.

There is a need for a system and method to help reduce the risk of the business when providing a service to a customer.

### BRIEF SUMMARY OF THE INVENTION

The object of the present invention is a system and method to allow a business greater flexibility in the sale of their product or service, while meeting profit goals. The price quoted to a customer, factors in the customer's rating. Therefore, allowing a business flexibility with lower rated customers. This allows a business to increase the price for customers who cost a service more in time or materials and reward other customers who are more considerate with lower prices or other incentives. This allows a business to attract desired customers and even block undesired customers.

The Maximum Profit Goal Software System (MPGSS) has an automatic and a manual mode, which is selected by the business. The business can choose to change the mode of operation at any time. The MPGSS calculates a price for the customer, based on configuration goal data entered into the system by the customer. In manual mode the business can engage directly with the customer in real time.

### BRIEF DESCRIPTION OF THE DRAWINGS

While the drawings illustrate a preferred embodiment, not all features are shown and, therefore, should not be considered as limiting the scope of this invention.

FIG. 1A shows a flow diagram of a preferred embodiment of the method and system of how a business can interact with the MPGSS.

FIG. 1B show a flow diagram of a preferred embodiment of the method and system of how the Maximum Profit Calculator works within the MPGSS

FIG. 1C shows a flow diagram of a preferred embodiment of the method and system of how a customer can interact with the MPGSS.

FIG. 1D shows a flow diagram of a preferred embodiment of the method and system of a payment and an interaction before and after payment between a business and the customer.

FIG. 1E shows a flow diagram of a preferred embodiment of the method and system of how an external business can interact with the MPGSS.

FIG. 1F shows a flow diagram of a preferred embodiment of the method and system of how an affiliate business can interact with the MPGSS.

FIG. 2 illustrates an example business account page of a preferred embodiment, which may be presented to a business account when interacting with the present invention.

FIG. 3 presents a diagram of a typical communications network of which the present invention may be implemented.

### DETAILED DESCRIPTION AND BEST MODE OF IMPLEMENTATION

This art may be applied to any service consumer—service provider community. The Maximum Profit Goal Software System (MPGSS) 1000 manages services for maximum profit. Given a potential customer, the MPGSS 1000 is designed to calculate a price quote, based on a business' Goal Completion Configuration (GCC) data 1135.

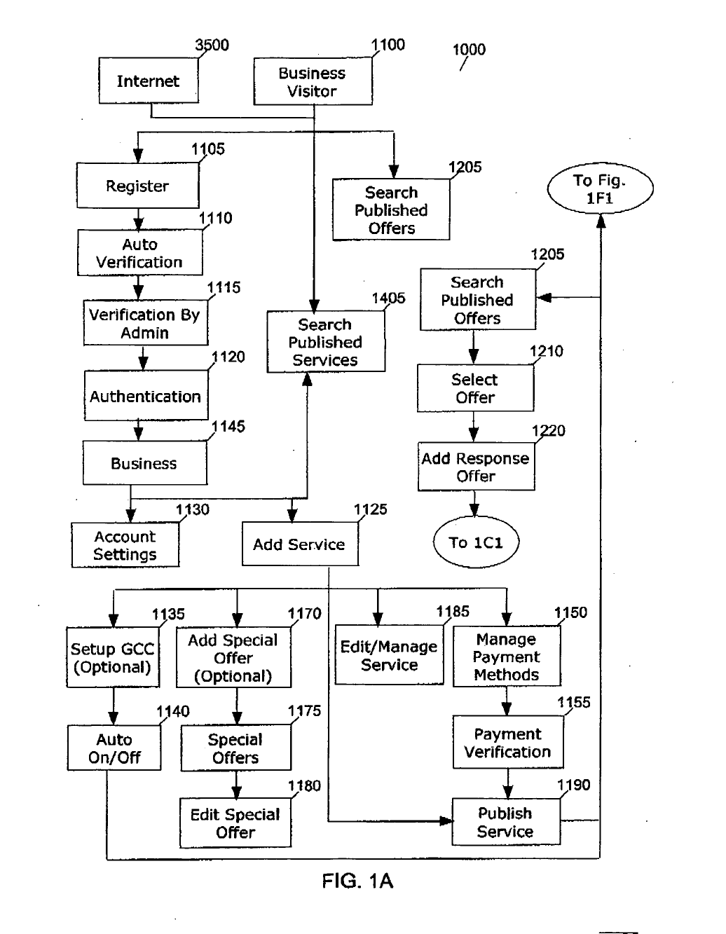

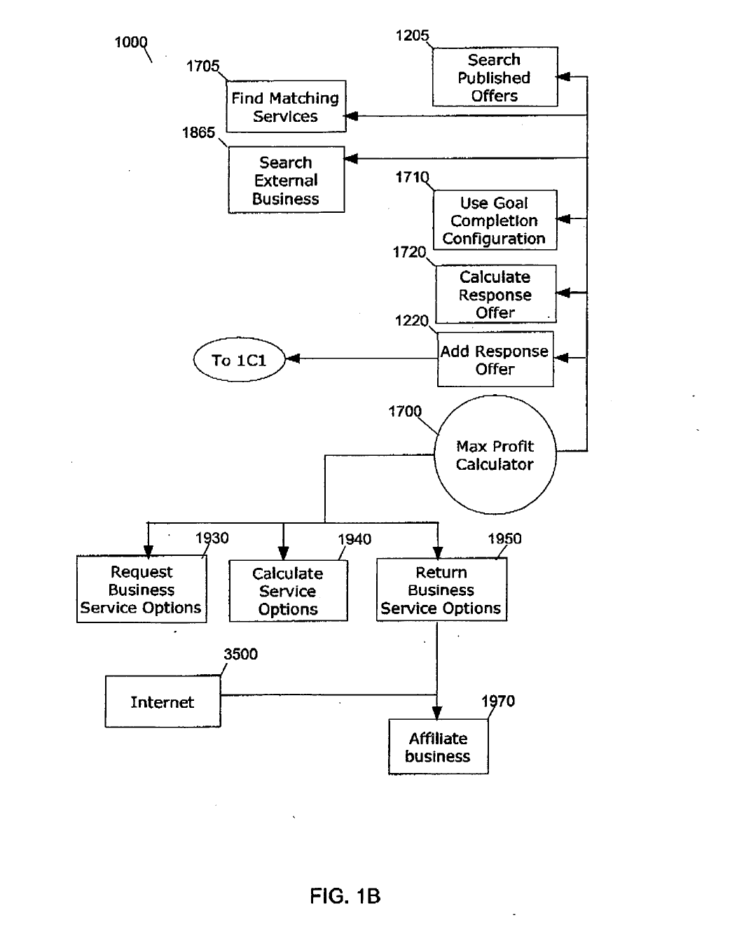

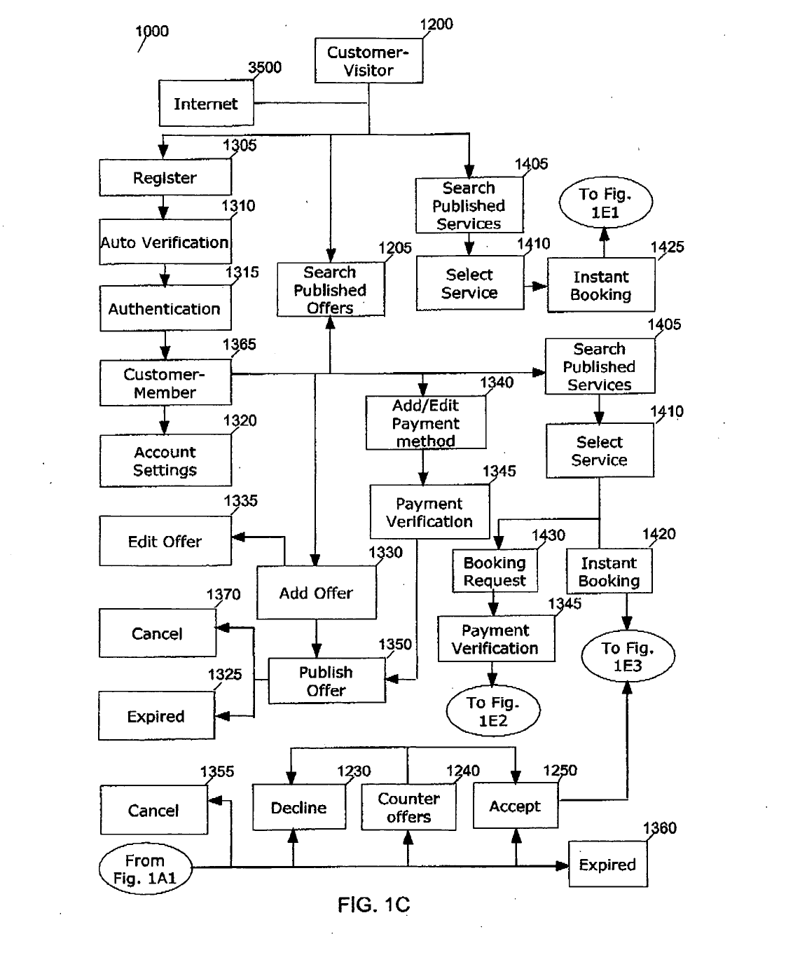

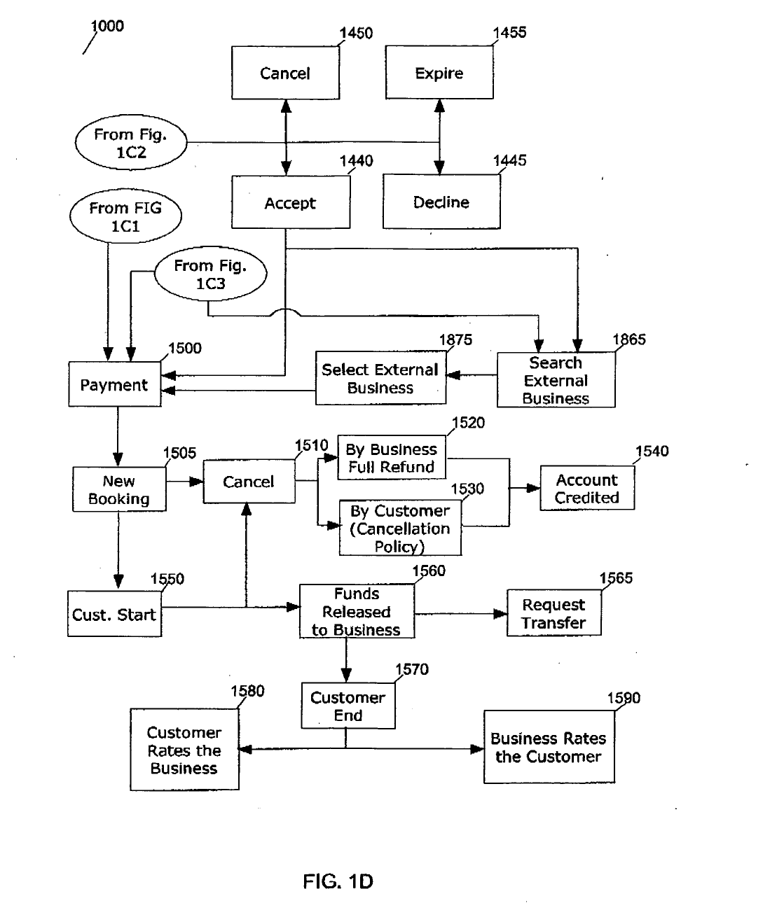

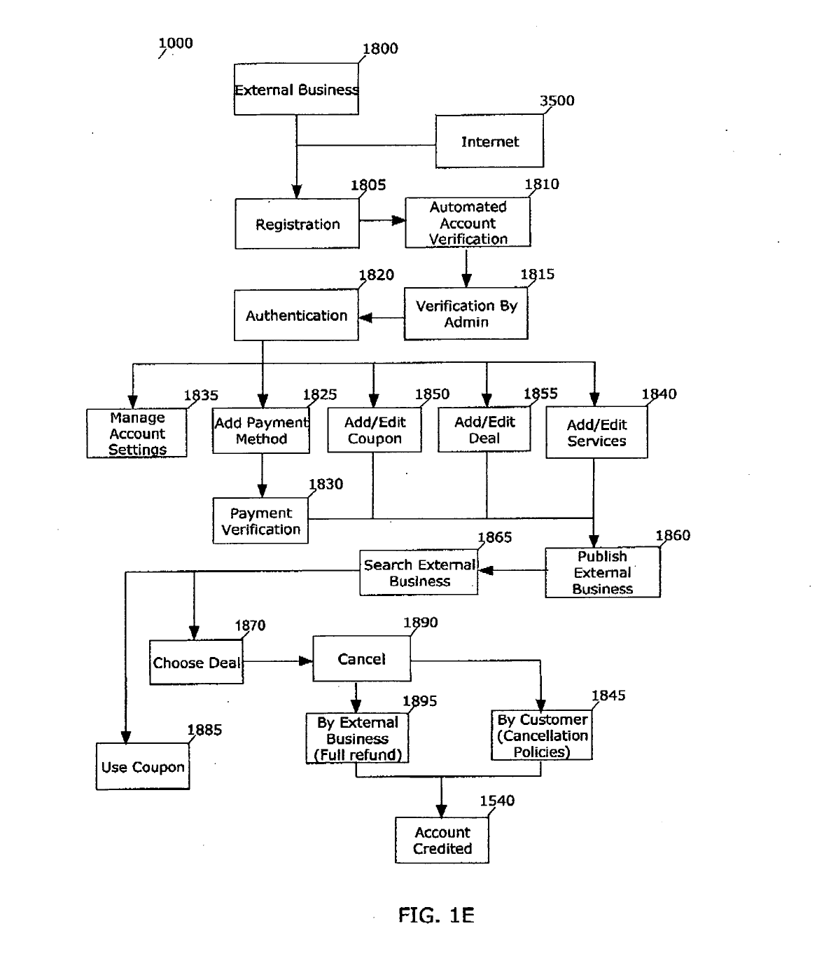

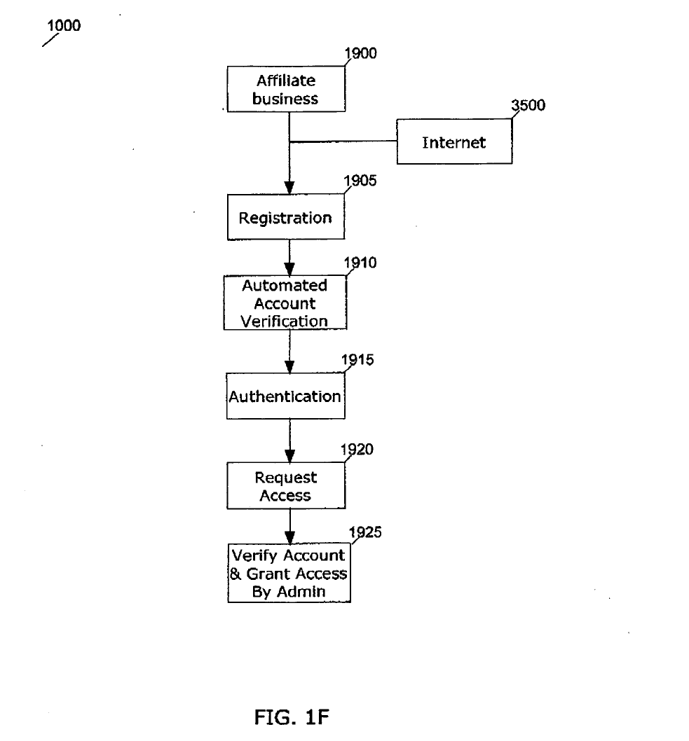

FIGS. 1A-F shows one preferred embodiment of the present invention, using a flow diagram. Some of the details described in this invention are not depicted in the corresponding drawings. Some of the obvious details illustrated in FIG. 1, may not be described herein. For example, if a user can login, then it is considered obvious that a user can logout. This exclusion was purposeful for the simplicity of interpreting the drawings, but should not be considered as limiting the scope of the invention.

FIG. 1A shows how a business might interact with and utilize the MPGSS 1000. To utilize the MPGSS 1000, a new business 1100 registers for an account 1105. The MPGSS 1000 handles the first part of the verification, which is an automated verification 1110 that can be completed by phone, email, etc. Once the automated verification is complete, the MPGSS 1000 will notify the administrator. The second portion of the verification is performed by an administrator 1115, who will make sure the business is legitimate. Then the administrator will grant account status, allowing a business to have a login. Upon authentication 1120, the business can set up their account online.

The MPGSS allows a business to manage multiple locations or services with their account 1125. The business can initialize and manage their account settings 1130. Account settings can include pictures, business info, profile information, notifications, preferences, privacy and security settings, etc. The business can set its own cancellation terms within the MPGSS (e.g., no cancellations within 24 hours of the service start date, 10% penalty for cancellations received less than a week prior to the service start date, etc.).

They can add or manage their payment methods 1150, which allows them to receive their money. Said payment method can include banking information (e.g., bank account number, Paypal™ account, credit card account, routing number, account name, account address, expiration dates, etc.) for processing payments and credits through the accounting system. A small transaction of less than one dollar can be created to verify the payment method 1155.

The MPGSS will then allow the business to publish its service 1190. Publishing a service allows customers and other businesses to view the details. It also allows the MPGSS to accept offers from customer-members or make offers in any mode. The MPGSS allows each service to be separately managed, thereby publishing 1190, suspending, editing, or deleting each as needed 1185 inside of a single account. In this, the MPGSS allows a business the flexibility to acquire and dispose of services without having to obtain separate accounts.

As part of their account set up, the business can also add special offers 1170 it wants to provide to potential customer-members 1365. Different types of offers can be chosen 1175. For example, a business might offer a 10% discount if booked within 24 hrs. or a lumber sale, with 15% off, in some date range. They might offer a complementary deal, such as stay a minimum of three nights and we'll give you a pair of tickets to the local theatre. Each offer will have its own expiration date. The MPGSS allows the business to manage (e.g., publish, suspend, delete, etc.) special offers separately, for each registered service 1180. Published Special offers are only visible when associated with a published service.

The Goal Completion Configuration (GCC) data allows the business to provide profit goal data 1135 to the MPGSS. The Goal Completion Configuration data 1135 will include items pertinent to a business' success (e.g., expense data, sales data, availability of resources, etc.). These can be tailored to meet business' needs. If the business has more than one service, it should complete GCC data for each service. Goal Completion Configuration data 1135 can be updated whenever needed.

Goal Completion Configuration data 1135 allows the MPGSS to manage a business for maximum profit goals. With consistent use, the MPC 1700 will collect data and can use that data to predict a goal that is most likely to be achieved for each service. The MPGSS will automatically collect business' data to perform calculations needed to predict and achieve goals.

Once the Goal Completion Configuration data 1135 is completed, a business can choose to run in automatic mode 1140. A business can switch between automatic and manual modes 1140 as they choose to. The system is designed to operate optimally in automatic mode.

In automatic mode, the MPGSS will automatically search for published offers 1205 in FIG. 1B. Once it finds a published offer it will check the criteria against those of the registered businesses to locate matching services 1705 of the businesses. For matching services MPC 1700 will take the Goal Completion Configuration data 1710, available external businesses 1865 and also taking into account some settings of the customer-member 1320 will calculate at least one response-offer 1720 to customer-member's offer 1350 for each matching service. It will return any matching response-offer to the customer-member 1220 in FIG. 1B. With the Goal Completion Configuration data 1135 provided in FIG. 1A, the MPGSS can also attach special offers as part of a response-offer. The list of response-offers returned to the customer-member contains information like price of the service, special offers, details and the location etc.

The Maximum Profit Calculator 1700 can also calculate and make counter-offers 1240 to the counter-offers 1240 of the customer-member. The response provided by the MPGSS can be to accept 1250 or decline an offer 1230 or counter-offer made by a customer-member 1240 as shown in FIG. 1C.

If chosen, the business can be notified about any counter-offers made by the customer-member, allowing the business to respond directly, thereby bypassing the Maximum Profit Calculator 1700, like in manual mode.

FIG. 1B shows another option that exists within the setting of the MPGSS 1000 to allow the MPGSS to distribute pricing, availability, etc. affiliate businesses 1970. In this way, the MPGSS 1000 can better help a business to meet its maximum profit goals defined in the GCC 1135. The business 1100 can choose to have it performed automatically, within automatic mode 1140, or the business can choose to perform that task manually on its own.

In manual mode a business can still search published offers 1205 and create response-offers 1220 in FIG. 1A. For response-offers the business can also define the expiration date and time for a customer-member, cancellation terms, thus allowing the customer-member time to consult, and explore other offers, prior to accepting an offer.

Another feature of the preferred embodiment allows a business to search for all customer inquiries and respond, should they choose.

FIGS. 1C and 1D show how a customer 1200, 1365 might interact with and utilize the MPGSS. The MPGSS 1000 is designed to work optimally with a customer-member 1365, who has created an account and whose account information (e.g., name, address, email, payment data, past purchasing habits, etc.) has been verified 1310. Once a customer-member has been authenticated 1315, they gain access to the all of the customer-member benefits of the MPGSS 1000. The customer-member can set up their account and manage their account settings 1320 (e.g., pictures, profile information, notifications, preferences, privacy and security settings, etc.).

The MPGSS allows the customer-member to add and store a payment method 1340. Said payment method can include banking information (e.g., bank account number, Paypal™ account, credit card account, routing number, account name, account address, expiration dates, etc.) for processing payments 1500 and credits 1540 through the account system. A small transaction of less than one dollar can be created to verify the payment method 1345. They can also manage the payment methods associated with their account 1340.

A customer-member 1365 can choose to receive offers from both targeted 1100 and external businesses 1800. A targeted business is the primary business 1100 the customer-member wants to do business with (e.g., lumber company, hotel, airline, etc.) and an external business 1800 would then be an associated business (e.g., machine company, museum, theme park, car rental, etc.) that a customer-member may additionally want to do business with. Once a customer-member sets their preferences, within the account settings 1320, that data is sent to the MPGSS 1000. This allows a customer-member to automatically choose special offers, both targeted and external business services 1875, FIG. 1D.

FIG. 1C shows how a customer-visitor 1200 can access and use the system without registering, but they will be limited to the information they can see 1405 and offers they can receive from the MPGSS 1000. The pricing a customer-visitor will see, will be a normal retail price 1410, lacking any special discounts that a customer-member might receive from external businesses.

The MPGSS will search the published services 1405 and return an initial target list to the customer, for that the customer is required to have some minimum inputs to MPGSS, like budget desired, dates, and location area to find items of interest, such as services, in the correct proximity. An attribute list (e.g., size and type attributes, rating, target price, smoke free, pet friendly, licensed, bonded, etc.) will allow the customer to further reduce the returned target list.

MPGSS will prioritize the initial target list. The target list may show ratings received from previous users for the given services. It may also show ratings received from nationally recognized rating systems. It may show a map with any location information entered by the customer, along with the target locations for convenience of the customer. The targeted business list also shows additional incentives offered by any given business for users, with a possibility to choose them for those, who are considered customer-members.

The customer can then choose 1410 one item of interest for purchase. If the at least one item is selected for purchase, a customer-visitor can only purchase by instant booking 1425. If a business' service does not accept instant bookings, then the customer-visitor 1200 will have to register 1305, FIG. 1C to become a customer-member 1365, or select a different item. If a customer-visitor 1200 would like to further pursue an item by making an offer 1430, they must become a customer-member 1200 first as in FIG. 1C.

Once an item is selected for purchase, payment details must be provided by the customer 1200, 1365 so that the purchase can be paid for 1500. Otherwise, the visitor 1200 is subject to losing their item.

The customer-member in FIG. 1C has additional options. A customer-member can choose to create at least one inquiry or offer 1330. In order to publish the offer, the customer-member must have at least one verified payment method 1345 on record. Once it is published 1350, either the MPGSS (in FIG. 1B) on behalf of the business or the business itself (in FIG. 1A) can make a response-offer 1220. The customer-member can also edit 1335 any previously made offers if they were not published.

Each offer 1330 has its expiration date. An offer 1330 can be cancelled 1370 at any time by the customer-member who created that offer. Offer 1330 also will automatically expire 1325 by the system on the expiration date, if none of the response-offers 1220 were accepted 1250.

In automatic mode, FIG. 1B shows how the MPGSS will automatically provide a response-offer for the business 1720, 1220 to any inquiries or offers 1350 made and published by a customer-member. A response-offer can be made by the MPGSS 1720, 1220 based on the Goal Completion Configuration data 1710, current customer-member rating, resource availability, external business' offers, etc. The response-offer 1720 can contain contingencies (e.g., expiration data, price, special offers, while the current supply remains available, different dates, external businesses offers, etc.).

If the MPGSS is in manual mode 1140, similar to automatic mode, the business can receive notifications about available offers in real time. As well as business can search published offers any time. The business can provide a response-offer to a chosen offer. After making a response-offer 1220 the business and the customer-member can choose to respond and interact with each other in real time. If the customer-member does not respond to or accept 1250 the response-offer 1220 until the end of the expiration time, then it will automatically expire 1360. The business can also cancel 1355 the response-offer. An offer will automatically be cancelled by the system 1355, if someone else has completed a purchase for the same item, mating it no longer available. Otherwise the customer-member can accept 1250, decline 1230, or provide a counter-offer 1240 to the business.

In FIGS. 1C and 1D, once a mutual agreement is made or an item is chosen for purchase, the business receives a new booking request 1430. For that the customer-member should have enough funds available on the account and/or a verified payment method 1345. The business can choose to decline the booking request 1445 from the customer-member (e.g., the business may be booking it over the phone with another customer, etc.). The customer-member can also cancel a requested booking 1450 prior to being charged for it 1500, without incurring any fees, though in same cases based on cancellation frequency it can be some penalties. However, once a booking is paid for, it is subject to the cancellation policies previously set by the business 1530. If the booking request is accepted 1440, the customer-member is being charged 1500 for the amount of the booking, either from the customer-member's account (if available) or from the provided payment method, and then a new booking is being created 1505. Once the booking request is accepted by the business, any other booking requests matching the same criteria are automatically cancelled by the system. If the booking request is neither accepted 1440, nor declined 1445 or cancelled 1450, it will automatically expire 1455 on the expiration date. Expired items are not considered active, cannot be modified, and can only be viewed by the users, who are directly associated with it.

The customer can select any payment method on file 1345, from FIG. 1D, to conclude the purchase 1500. The customer-member also has the option to add additional payment methods to their account 1340. The MPGSS 1000 will ask the customer-member for confirmation of the payment method and the purchase transaction details prior to processing the payment. Once the customer has confirmed the details of the purchase, the system will try to charge the funds from the provided payment method using a 3^{rd} party payment systems (e.g. bank, Paypal™, etc.) or charge the amount from the customer-member's account.

Upon approval of the payment, the MPGSS 1000 notifies the business and adjusts their available resources accordingly. The MPGSS 1000 creates the confirmation with the details of the transaction. The system notifies the customer (e.g., by email, phone, etc.) about the details of the payment and about the service to be used. A customer-visitor upon providing a payment method should provide a contact information (e.g. email, phone, etc.) to receive their confirmation details, including security code. Additionally, they can print out their confirmation page. Contact information will be also used when making a cancellation. Here, again cancellation policies will be applied.

If the payment is not successful for some reason (e.g., invalid payment information, etc.), the MPGSS can generate a notice to the customer about possible reasons of the failure. The customer is allowed to provide another payment method to make the payment.

Payment to a business is held for a period of time after the customer start using the service 1550. After a period of time, following of the start date, the accounting system releases the available funds in the business' account 1560, making the funds available for transfer. A business can send a request 1565 to transfer any portion of the released funds to their account on record. The accounting system will send the funds available to be business' balance to the destination that they chose.

In the event that a business has to cancel 1510 a previously confirmed transaction (e.g., hurricane, earthquake, fire, closing, etc.) the customer will receive a full refund 1520. If a customer has to cancel 1510 a previously confirmed transaction for any reason, a cancellation confirmation will be created, showing the terms of the cancellation 1530. Customer-visitor must provide the security code assigned with the confirmation, since there is no other record in which to confirm that customer-visitor. A customer-visitor should use the contact information and/or a security code upon request and/or in case of cancellation. Upon confirmation of cancellation, a notice will be sent by the MPGSS, to the customer and any businesses involved in the transaction being cancelled. The MPGSS will process the appropriate credit 1540 to the customer's payment method used in the transaction payment 1500 or to customer's account. The accounting system will charge the customer' account or payment method appropriately.

MPGSS allows the scheduling of available resources without over-booking them. It records the beginning and ending dates of all transactions. Once a business confirms (e.g., through calendar interface (CI)) that a customer transaction has started 1550, MPGSS will update the customer-member's account. After this confirmation during predefined period of time the funds will be released to the business 1560. MPGSS will automatically update the customer-member's account on end date of the service. The customer-member completed transaction 1570 is also what triggers the system to notify both the business and the customer-member requesting a rating to be submitted 1590, 1580. When the ratings by the customer-member 1580 and by the business 1590 have been received, the rating will be added to the rating of their corresponding account.

Once the transaction is concluded, the available resources are updated as needed. Additionally the calendar interface can be used to schedule other resources that might be needed (e.g., cleanup, down time, maintenance, etc.). In automatic mode, the MPGSS will factor in any unavailable resources and adjust conditions for further usage of the service.

FIG. 1E shows how an external business 1800 might also interact with and utilize the MPGSS. Their account works similar to that of a standard business and can be purchased at the same time as an offer from a standard business. They can make the purchase prior to or after payment for their business offer.

The external business registers for an account 1805. The MPGSS handles the first portion of the verification, which is an automated verification 1810 that can be completed by phone, email, etc. Once the automated verification is complete, the MPGSS will notify the administrator. The second portion of the verification is performed by an administrator 1815, who will make sure the business is legitimate. Then the administrator will grant account status, allowing a business to login. Upon authentication 1820, the external business can set up their account online.

The external business can initialize and manage their account settings 1835. Account settings can include pictures, business info, profile information, notification, preferences, privacy and security settings, etc.

They can add or manage their payment methods 1825, which allows them to receive their money. Said payment method can include banking information (e.g., bank account number, Paypal™ account, credit card account, routing number, account name, account address, expiration dates, etc.) for processing payments and credits through the accounting system. A small transaction of less than one dollar can be created to verify the payment method 1830.

As part of their account set up, the external business can add external business services 1840, coupons 1850, or deals 1855 it wants to provide potential customers. For example, a tour guide business might partner with a registered business to offer a 15% discount on a tour 1855 if booked with that particular registered business. They might offer a complementary deal, such as get a 10% discount on a car rental if booked at the same time as a service booking. A restaurant might offer a coupon good for $2 off of a dinner meal. Each offer will have its own expiration date. The MPGSS allows the business to manage (e.g., publish, suspend, delete, etc.) special offers separately.

The external business can set its own cancellation terms within the MPGSS (e.g., no cancellations within 24 hours of the beginning date, 10% penalty for cancellations received less than a week, etc.).

FIG. 1E shows how the cancellation procedures work the same for external businesses as they do for a targeted business. That being, in the event that a external business has to cancel a previously confirmed transaction (e.g., hurricane, earthquake, fire, closing, etc.) the customer will receive a full refund 1895. If a customer has to cancel a previously confirmed transaction for any reason, a cancellation confirmation will be created, showing the terms of the cancellation 1845. Upon confirmation of cancellation, a notice will be sent by the MPGSS, to the customer and any businesses involved in the transaction being cancelled. The MPGSS will process the credit 1540 to the customer's account or to payment method used in the transaction payment 1500. The accounting system can charge the businesses accounts appropriately. The MPGSS will request a refund payment from the business' account if needed.

Once the account is setup, the MPGSS will then allow the external business to publish 1860 its business services 1840, coupons 1850, deals 1855. Publishing an external business 1860 allows customers and other businesses to search for and view 1865 the external business' deals. A customer-member can choose to receive offers from external businesses automatically.

FIG. 1F shows how an affiliate business 1900 or other affiliate 1600 might interact with and utilize the MPGSS. An affiliate business registers for an account 1905. The MPGSS handles affiliate business' account's automated verification 1910 that can be completed by phone, email, etc. Once the automated verification is complete 1910, the business can login and complete the necessary steps to receive services. Upon authentication 1915, the affiliate business can request access 1920. The second portion of the verification is performed by an administrator, who will make sure the affiliate business is legitimate and grant access 1925 to it.

Once the affiliate businesses are granted access, they can receive availability, pricing, and other options from businesses.

The Maximum Profit Calculator 1700, FIG. 1B, will request from the businesses 1930, details, such as available options. The Maximum Profit Calculator 1700 will then calculate a variety of business service options 1940. These business service options 1950 will be returned to the affiliate business 1970, so that they can book services.

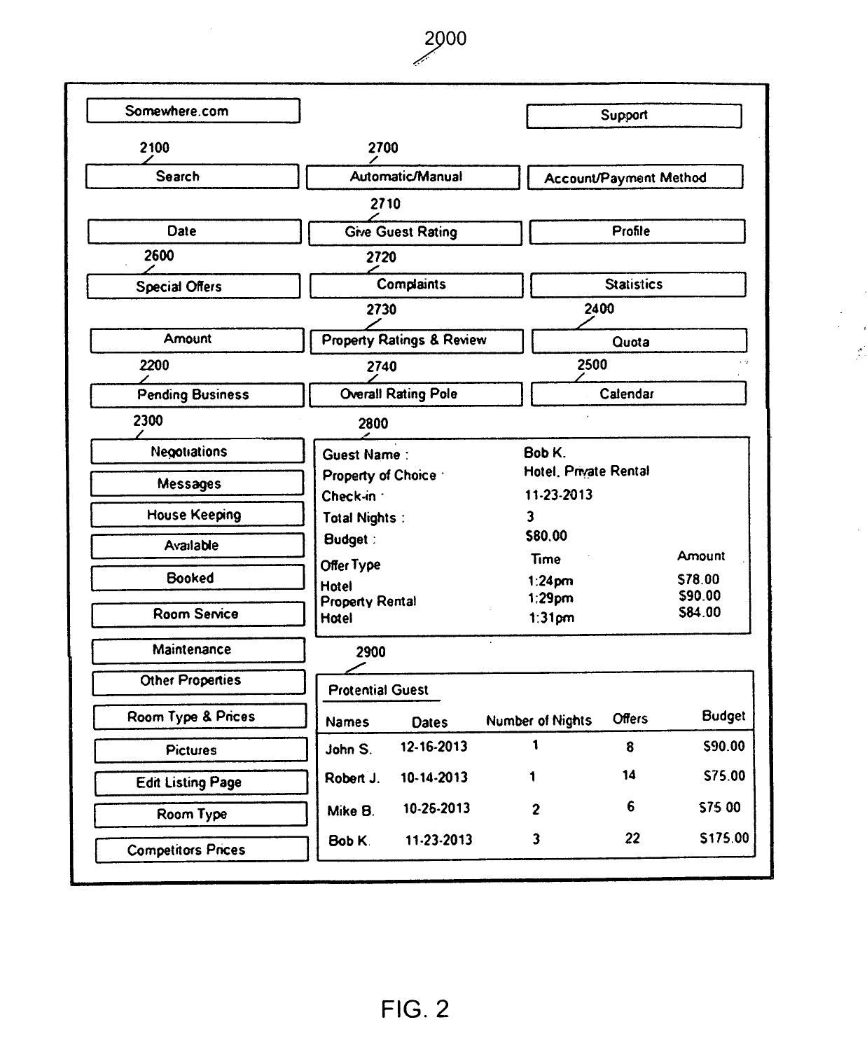

In an example of a preferred embodiment of this platform, FIG. 2 shows an example business perspective 2000 in a preferred embodiment for providing travel services. This particular screen is for a business that books overnight customers, to interact with the MPGSS.

The business can perform a search 2100 to find potential customers. In the customer window 2900, the business can see attributes associated with potential customers for their area. These attributes can include: a partial name, the desired check-in date, the number of nights that the customer desires, the number of offers they have received so far, and how much they are looking to spend. The business can change the modes between automatic and manual 2700.

The business can choose to view any pending response-offers 2200 they may have made. These would be response-offers that have been extended and whose expiration dates have not yet reached maturity. The offers conditions can be different based on user's activity, rating, etc.

The business can look at all active negotiations 2300 they are engaged in or can engage in. In a customer window 2800, the business can see attributes associated with a particular customer for their area. These attributes can include: a partial name, the type of service desired, the desired check-in date, the number of nights that the customer desires, how much they are looking to spend, and what response-offers they have received so far.

A business can set its desired quota 2400 and view its current progress toward reaching that quota.

The calendar 2500 shows the customers that are booked and also provides an active interface that ensures that the availability is kept current each time a customer reserves or cancels a room, the availability is updated. A business can enter any special offers 2600 they want to extend to potential customers. These offers will include any expiration information (e.g., if they want to offer a potential customer a 10% discount if the customers books a reservation within 24 hrs.). They can accept outside discounts by having the customer enter a discount code.

A business can choose to run in automatic or manual mode 2700. They can also change between modes when desired.

Upon customer check-out, the business will receive an email reminding them to provide a customer rating 2710. Another option allows the business to view all complaints that have been made about the business 2720. This educates the business in what it may be doing inadequately, allowing them to make changes and improve to better meet their goals. The business can add a note or comment in their profile page that reflects this (e.g., “Now under new management. We appreciate your comments and are working to make improvements for you. We look forward to your continued support. Let us know how our new management is working for you.”). This allows a business to increase or retain its business base, thus increasing profits. A business can look at all of the ratings and reviews 2730 they have received from customers. The business can also look at their overall rating 2740. They can compare this with other competitors in the area or of those within the same franchise.

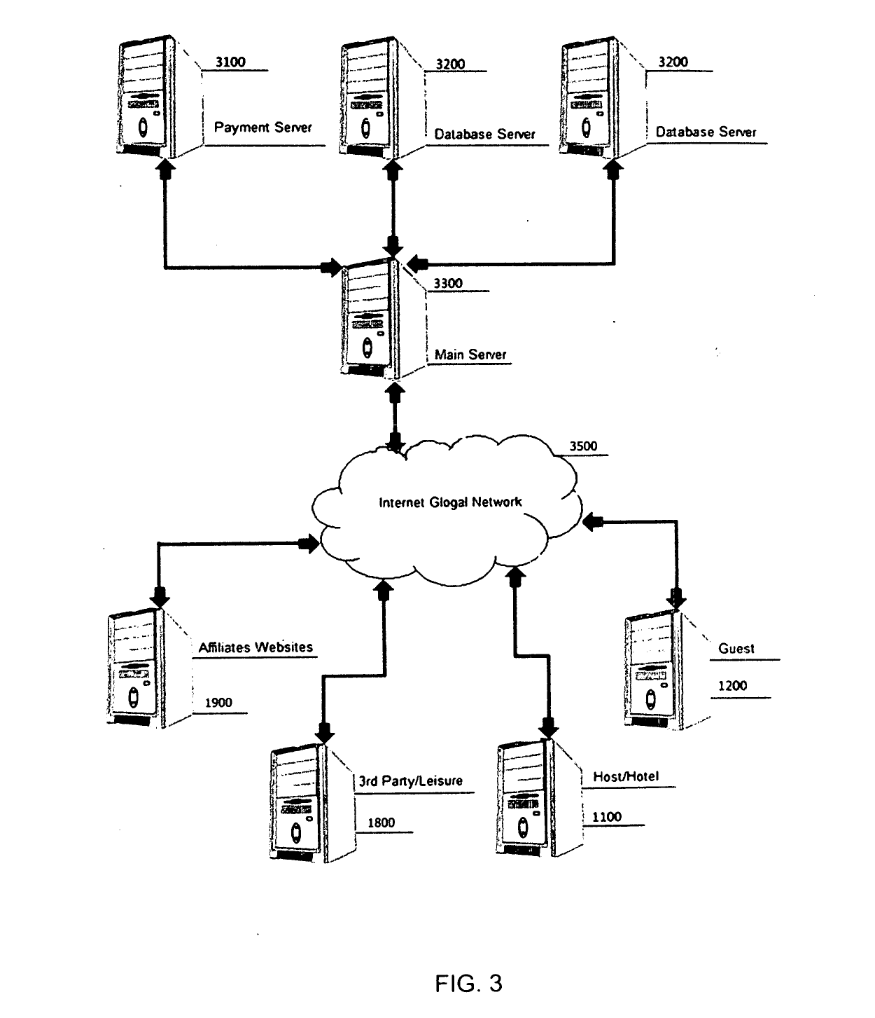

FIG. 3 shows one embodiment of a communications network 3500, which can be used to enable this invention. This depiction should in no way limit the other possible embodiments that could be used to enable this invention. The depicted embodiment consists of at least one payment server 3100, at least one database server 3200, a main server 3300, at least one user device (e.g., computer, tablet, phone, etc.) 1200, and a global communications network, such as a telephone line, LAN, Internet, or other communication means 3500 for interconnecting the plurality of users devices 1100, 1200, 1800, 1900 with the payment server 3100 and database servers 3200.

In one embodiment, the payment server 3100 and the at least one database server 3200 are connected to a main server 3300, to facilitate communication between the payment server 3100 and the at least one database server 3200.

The payment server 3100 contains payment information needed to process payments to and from users 1200 and hosts 1100, 1800, 1900.

Another option of the preferred embodiment would allow the user to select the number of days or nights desired and a date range acceptable and any preference for days of the week (i.e., Mon, Tues, Weds, etc.). The MPGSS would then calculate the best consecutive dates and return those options. This allows a customer that has flexibility the opportunity to avoid a peak travel time for a specific location. It also allows a service to capitalize on their lower productivity periods and make them more profitable. Often when a customer calls a business to arrange a given number of dates, if one of the dates isn't available, the representative doesn't give the customer any options. The representative seldom says, if you can slide your plans by one day, then we can accommodate you, resulting in a loss of business.

Another option of the preferred embodiment would allow the user to prioritize the target list by preferred dates, price, most amenities, alphabetically, rating, etc.

Another option of the preferred embodiment allows the user to select and delete businesses that they are not interested in. Thus, reducing the number of desired options left to choose from,

Another option of the preferred embodiment allows a registered external business to add and supply external business offers to a user when a user shows an interest in a external business (e.g., a coupon good for 10% off of paint with the purchase of 25 ft of lumber, buy two museum tickets and get the third one free when staying at the Museum Hotel, get an additional 5% off when you pay with your Paypal™ account, etc.)(25).

One skilled in the art can recognize that this invention can be applied to other embodiments without departing from the scope of this invention.

What is claimed is:

1. A method for assisting a supplier in reaching its goals, by automatically processing and responding to a potential consumer's request for a good or service using a communication device, comprising: goal completion configuration data entered by a supplier; calculating and replying with an offer response; the consumer having supplied a location for the consumer's requested good or service, received a date range for requested good or service, received a price range, received an accepted payment, received additional desired attributes; allowing a consumer to make a counter-offer; processing previously accepted payment means.

2. The method of claim 1, wherein said offer is based on consumer's data.

3. The method of claim 2, wherein said data includes the consumer's rating.

4. The system of claim 1, wherein said goal completion configuration data can be profit or quota based.

5. The method of claim 1, wherein said consumer may be handled differently if not registered.

6. The method of claim 1, wherein said offer response has a specific expiration.

7. The method of claim 1, wherein said offer response may be bundled with other offers for an additional value.

8. The method of claim 1, wherein said offer response can be made directly by a supplier.

9. The method of claim 1, wherein said offer responses can specifically be deleted from the returned list.

10. The method of claim 1, wherein said returned offer responses are prioritized by the greatest number of attributes matching consumer's request.

11. The method of claim 1, wherein said offer responses can be reprioritized.

12. The method of claim 1, wherein said supplier can search for registered consumers and send targeted consumers special offers.

13. The method of claim 1, wherein said supplier can view all offers made to a particular consumer.

14. The method of claim 1, wherein said supplier can give a rating to a consumer.
A system of hardware and software that assists a supplier in reaching its goals, by automatically processing and calculating an offer for a good or service, comprising: goal completion configuration data entered by a supplier; calculating and replying with an offer response; the consumer having supplied a location for the consumer's requested good or service, received a date range for requested good or service, received a price range, received an accepted payment, received additional desired attributes; allowing a consumer to make a counter-offer.

16. The system of claim 15, wherein said offer is based on consumer's data.

17. The system of claim 16, wherein said data includes the consumer's rating

18. The system of claim 15, wherein said supplier can give a rating to a consumer.

19. The system of claim 15, wherein said supplier can search for registered consumers and send targeted consumers special offers.

20. The system of claim 15, wherein said offer response may be bundled with other offers for an additional value.
